(19) United States
(12) Patent Application Publication
(10) Pub. No.: US 2026/0237160 A1
(43) Pub. Date: Aug. 13, 2026

(54) CONTEXT AWARE RESOURCE SHARING IN SPATIAL COMPUTING

(71) Applicant: INTERNATIONAL BUSINESS MACHINES CORPORATION, Armonk, NY (US)

(72) Inventors: Jessica Nahulan, Vaughan (CA); Jeremy R. Fox, Georgetown, TX (US); Tiberiu Suto, Franklin, NY (US); Carolina Garcia Delgado, Zapopan (MX)

(21) Appl. No.: 19/047,902

(22) Filed: Feb. 7, 2025

(51) Int. Cl. G06T 19/00; G06F 3/01

(52) U.S. Cl. CPC G06T 19/006; G06F 3/013

(57) ABSTRACT

A method, system, and computer program product configured to perform operations including: interpreting an attention of a user relative to a specific item within a virtual environment; determine user interest for the specific item by analyzing eye movement patterns of the user; generating a copy of the specific item based on the determined user interest; generating context-based tags for the copy of the specific item; receiving a natural language request for data associated with the specific item, where the data associated with the specific item is determined based on the context-based tags for the copy of the specific item; and transmitting the copy of the specific item to a user device to be displayed at the user device in response to the natural language request.

### BACKGROUND

Aspects of the present invention relate generally to spatial computing and context-aware resource sharing based on a determined user interest.

Spatial computing refers to the technology and methods that enable the interaction between digital and physical spaces. It involves the use of devices and systems that can sense, interpret, and respond to spatial data, such as three-dimensional (3D) environments, physical objects, and human movements. This field encompasses a wide range of technologies, including augmented reality (AR), virtual reality (VR), mixed reality (MR), and geospatial mapping. Spatial computing allows for immersive experiences where digital content can be integrated with the real world.

### SUMMARY

In a first aspect of the invention, there is a method including: interpreting an attention of a user relative to a specific item within a virtual environment; determine user interest for the specific item by analyzing eye movement patterns of the user; generating a copy of the specific item based on the determined user interest; generating context-based tags for the copy of the specific item; receiving a natural language request for data associated with the specific item, wherein the data associated with the specific item is determined based on the context-based tags for the copy of the specific item; and transmitting the copy of the specific item to a user device to be displayed at the user device in response to the natural language request.

In another aspect of the invention, there is a computer program product comprising one or more computer-readable storage media and program instructions stored on the one or more computer-readable storage media to perform operations comprising: interpreting an attention of a user relative to a specific item within a virtual environment; determine user interest for the specific item by analyzing eye movement patterns of the user; generating a copy of the specific item based on the determined user interest; generating context-based tags for the copy of the specific item; receiving a natural language request for data associated with the specific item, wherein the data associated with the specific item is determined based on the context-based tags for the copy of the specific item; and transmitting the copy of the specific item to a user device to be displayed at the user device in response to the natural language request.

In another aspect of the invention, there is a computer system comprising a processor set, one or more computer-readable storage media, and program instructions stored on the one or more computer-readable storage media to cause the processor set to perform operations comprising: interpreting an attention of a user relative to a specific item within a virtual environment; determine user interest for the specific item by analyzing eye movement patterns of the user; generating a copy of the specific item based on the determined user interest; generating context-based tags for the copy of the specific item; receiving a natural language request for data associated with the specific item, wherein the data associated with the specific item is determined based on the context-based tags for the copy of the specific item; and transmitting the copy of the specific item to a user device to be displayed at the user device in response to the natural language request.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4 shows a flowchart of an exemplary method in accordance with aspects of the present invention.

### DETAILED DESCRIPTION

Aspects of the present invention relate generally to spatial computing and context-aware resource sharing based on a determined user interest. As users interact through the virtual-reality and augmented-reality environments, users happen upon an endless number of experiences and see an endless number of objects and resources. Conventional systems do not have efficient ways for users to retrieve past seen and/or experienced resources. Conventional systems do not have the ability to share past seen and/or experienced resources with other users. Currently, conventional spatial computing platforms lack a systematic and memory-efficient method for automatically copying, storing, and sharing items with other users based on the primary user's gaze and interest levels. Thus, conventional technologies suffer from problems including inefficiencies, an inability to share past seen and/or experienced resources with users, and an inability to copy, store, and share items based on a user's gaze and/or interest.

Implementations of the invention address this problem by providing a method, system, and computer program product that provides efficient ways for sharing past seen and/or experienced resources with users and provides an ability to copy, store, and share items based on a user's gaze and/or interest. For example, in accordance with aspects of the instant invention, the methods, systems, and computer program products described herein provide virtual and/or augmented reality applications that uses eye-tracking technology and advanced analytics to autonomously copy items that a user shows interest in. Embodiments generate copies to online resources equivalent to or describing the real world copied item, or when appropriate an image of the real-world object can be copied. Further, rather than storing full copies of items, aspects of the instant invention save memory space by storing pointers or references to these items. In this manner and in view of other advantages disclosed herein, aspects of the instant invention improve and advance the technology of spatial computing in a practical application by improving memory efficiency, allowing personal recording of items, and facilitating easy sharing of experiences and discoveries, thus promoting better communication, collaboration, and social connection in virtual and augmented-reality worlds.

According to an aspect of the present invention, a method, system, and computer program product include: interpreting a user's attention and interest in specific items within a virtual or augmented reality environment through eye-tracking technology integrated into virtual reality (VR) devices and/or augmented reality (AR) devices, capable of capturing gaze data in real time; analyzing gaze patterns to determine user interest, and executing automated copying mechanisms to generate copies or references of items the user interacts with or pays attention to, these references being stored in a database for future user access; generating, by a contextual tagging system using Natural Language Processing (NLP), context-based tags for copied items; enabling a user to make complex requests in natural language, by processing and executing the complex request with all copied items being linked to their original sources for transparency and traceability; and storing, by an intelligent memory management system, references instead of full copies of items.

In embodiments, the computer-implemented method, system, and computer program product further includes adapting, using a dynamic processing mechanism, pasted items according to the current context and user needs.

In embodiments, the computer-implemented method, system, and computer program product further includes, utilizing the storing to create local copies if an original item is deleted, to ensure efficient memory usage and reliable access to copied items for future pasting within contextual reasoning parameters supplied by a user or a provider.

In embodiments, the computer-implemented method, system, and computer program product further includes, building user-friendly interfaces for users to interact with the system, access copied items, review descriptions, review tags, review source links, and make specific requests; and enabling intuitive, immersive, and seamlessly blending into an AR environment and/or VR environment.

In embodiments, the computer-implemented method, system, and computer program product further includes, intelligently tracking user interests, copying and processing items in a context-aware manner, handling advanced user requests, and efficiently managing memory producing spatial computing copy and pasting with interactive natural language processing based infusions.

In embodiments, the computer-implemented method, system, and computer program product further includes intelligently modifying the item according to requirements of a user; and reordering sequences, or anonymizing sensitive information.

Implementations of the present invention are necessarily rooted in computer technology. For example, interpreting an attention of a user relative to a specific item within a virtual environment; determine user interest for the specific item by analyzing eye movement patterns of the user; generating a copy of the specific item based on the determined user interest; generating context-based tags for the copy of the specific item; receiving, by the processor set, a natural language request for data associated with the specific item; and transmitting the copy of the specific item to a user device to be displayed at the user device in response to the natural language request are computer-based and cannot be performed in the human mind. Furthermore, the computations required for performing the machine learning techniques described herein are beyond what a human mind could perform using pen and paper. For example, a human mind cannot determine user attention and/or focus from raw gaze data using a convolutional neural network CNNs for pattern recognition, a recurrent neural network to capture temporal dynamics in eye movement data, and/or any other machine learning model used for tracking a user attention and/or focus, because doing so is beyond what a human mind is capable of performing.

It should be understood that, to the extent implementations of the present invention collect, store, or employ personal information provided by, or obtained from, individuals (e.g., data capture during an individual's day-to-day activities, including name, address, or other personal information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved spatial computing and context-aware resource sharing code (program) 200. In addition to program 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

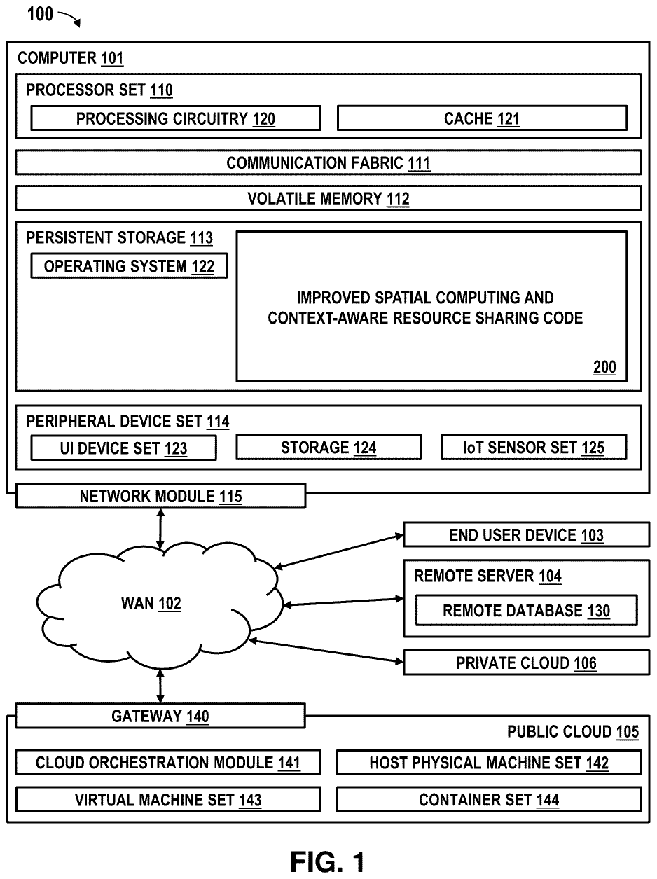

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in program 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in program 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

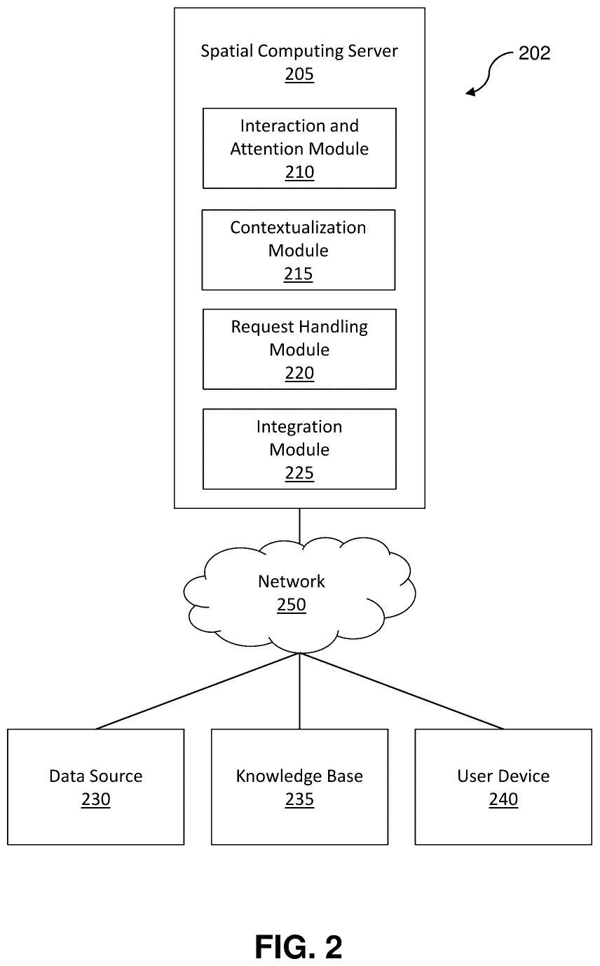

FIG. 2 shows a block diagram of exemplary environment 202 in accordance with aspects of the present invention. In embodiments, environment 202 includes spatial computing server 205, data source 230, knowledge base 235, user device 240, and network 250.

Spatial computing server 205 may comprise one or more instances of computer 101 of FIG. 1. In another example, spatial computing server 205 may comprise one or more virtual machines or containers running on one or more instances of computer 101 of FIG. 1. In embodiments, spatial computing server 205 communicates with data source 230 and user device 240 via network 250, which may comprise WAN 102 of FIG. 1. In embodiments, data source 230 may comprise one or more data sources each comprising an instance of remote database 130 and/or remote server 104 of FIG. 1. In embodiments, knowledge base 235 may comprise one or more data sources each comprising an instance of remote database 130 and/or remote server 104 of FIG. 1. In embodiments, user device 240 comprises an instance of EUD 103 of FIG. 1. There may be plural different instances of user device 240 including, for example, personal computing devices, virtual reality (VR) devices, augmented reality (AR) devices, and/or any other device useful for generating and or storing spatial computing information as disclosed herein. The different instances of user device 240 may be used by different users, evaluators, operators, technicians, etc.

In embodiments, spatial computing server 205 of FIG. 2 comprises interaction and attention module 210, contextualization module 215, request handling module 220, and integration module 225, each of which may comprise modules of the code of program 200 of FIG. 1. Such modules may include routines, programs, objects, components, logic, data structures, and so on that perform a particular task (or tasks) or implement a particular data type (or types) that the code of program 200 uses to carry out the functions and/or methodologies of embodiments of the present invention as described herein. These modules of the code of program 200 are executable by computer 101 of FIG. 1 (e.g., processing circuitry 120 of FIG. 1) to perform the inventive methods as described herein. Spatial computing server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, spatial computing server 205 is configured to facilitate communication between interaction and attention module 210, contextualization module 215, request handling module 220, integration module 225, and external storage (e.g., data source 230 and/or knowledge base 235) and devices (e.g., user device 240) via network 250.

In embodiments, spatial computing server 205 is configured to gather and configure essential systems and technologies to support the operations of interaction and attention module 210, contextualization module 215, request handling module 220, and integration module 225. In embodiments, spatial computing server 205 interacts with data source 230 to set up and establish a database management system (DBMS). As used herein, a DBMS refers to a software system designed to manage, store, and organize data in a structured way. It allows users to create, read, update, and delete data while ensuring data integrity, security, and efficient access. In embodiments, the DBMS 312 serves as a central repository for objects and data that are referenced by users in an application. In embodiments, the DBMS 312 provides essential functionalities such as data storage, query processing, transaction management, and backup recovery, ensuring that data is available, consistent, and accessible. In embodiments, the DBMS 312 may be implemented using cloud-based solutions or any other scalable and reliable managed database services suitable for handling large volumes of data with high availability.

In accordance with aspects of the present invention, interaction and attention module 210 is configured to obtain eye-tracking data and/or other user-interaction data from a VR device and/or an AR device, e.g., user device 240, worn by a user. In embodiments, tracking eye movements may be performed by capturing gaze data of the user. In embodiments, interaction and attention module 210 is further configured to interpret an attention or interaction of a user based on the obtain eye-tracking data and/or other user-interaction data. For example, in embodiments, the attention of the user relative to a specific item within a virtual reality environment and/or an augmented reality environment may be determined, analyzed, and/or interpreted based on the tracked eye movements.

In embodiments, interaction and attention module 210 is further configured to analyze and/or interpret user eye movements including gaze patterns. By tracking eye movements such as fixation points (where the eyes are focused), saccades (quick eye movements between fixations), and blink rates, the model can infer a user level of engagement, identify areas of interest, and/or predict user intent. In embodiments, the eye movements are tracked using specialized sensors and/or cameras within the VR and/or AR devices to monitor a user gaze in real-time. In embodiments, the eye tracking may use infrared light to illuminate the eyes and/or cameras to capture reflections from the cornea and pupil. By analyzing these reflections, the system can precisely determine the direction of a user gaze. In embodiments, module 210 analyzes and/or interprets user eye movements relative to specific items. For example, if a user is walking down the street and looks at an advertisement for at least a threshold length of time, interaction and attention module 210 may determine that the user is interested in the contents of the advertisement.

In embodiments, interaction and attention module 210 employes a machine learning model trained to analyze and/or interpret the user eye movements and gaze patterns. For example, the machine learning model may be trained to analyze gaze patterns and/or to determine where the user is focusing attention on a screen or in a physical environment. As used herein, the machine learning model used by interaction and attention module 210 may include one or more of supervised learning models (e.g., support vector machines (SVM), random forests models, and/or logistic regression models), unsupervised learning models (e.g., clustering algorithms and/or dimensionality reduction models), deep learning models (e.g., convolutional neural networks (CNN), recurrent neural networks (RNN), long short-term memory (LSTM) networks, and/or deep reinforcement learning (DRL)), and/or any other machine learning model capable of inferring a user intent based on a received user interaction and/or a user eye moment. In such embodiments, the machine learning model(s) may have access to historical and/or real time user attention data and/or historical 3D data (i.e., one or more instances of knowledge base 235 of FIG. 2). In embodiments, the machine learning model(s) may be trained using the historical and/or real time user attention data and/or historical 3D data.

In embodiments, interaction and attention module 210 is further configured to generate a copy of the specific item based on the determined user interest. In other words, interaction and attention module 210 may comprise and/or employ an autonomous copying system that generates a copy of an item that caught the user's attention. Returning to the example of a user walking down the street and looking at an advertisement for at least a threshold length of time, upon determining that the user is interested in the contents of the advertisement, interaction and attention module 210 may automatically generate a copy of the advertisement for future retrieval.

In accordance with aspects of the present invention, contextualization module 215 is configured to generate context-based tags for the specific item copied by interaction and attention module 210. For example, contextualization module 215 may analyze the item and generate tags that reflect its content, relevance, and/or relationship to the user's current context. This may include tags related to the type of content, location, time of day, and/or the user's previous interactions or preferences. In embodiments, these tags can help organize and categorize the copied items for efficient future retrieval, enabling personalized content recommendations, and/or context-aware search functionalities. Additionally, contextualization module 215 may leverage metadata such as geographic data, social signals, and/or environmental factors to enhance the relevance of the generated tags.

In embodiments, contextualization module 215 employs a machine learning model to generate context-based tags for the specific item copied by interaction and attention module 210. For example, contextualization module 215 may use machine learning models such as natural NLP models, CNNs, and/or RNNs to analyze the content of the item and/or generate relevant tags. In embodiments, NLP models may be used to process textual content to extract key terms, sentiments, and entities. In embodiments, CNNs may be used to analyze visual content (e.g., images or videos) for identifying patterns or objects. In yet additional embodiments, RNNs, may be used to capture sequential data such as interactions over time, allowing the system to better understand the context and the user's evolving preferences. These machine learning models, trained on large datasets, can help contextualization module 215 adapt and improve the tagging process over time, creating more accurate and personalized context-based tags. In embodiments the training data (e.g., historical tagging and machine learning data) may be stored in a database (i.e., one or more instances of knowledge base 235 of FIG. 2).

In embodiments, contextualization module 215 includes a feedback loop to retrain the machine learning models. In other words, contextualization module 215 may be configured to update its machine learning model(s) based on a user's natural language requests. For example, the system may learn and adapt to a user's language and preferences through the user's natural language requests. This information can help refine the context-based tags, improve the relevance of content suggestions, and enable the system to more accurately predict the user needs and interests. By continuously incorporating user feedback, the system can better understand nuanced preferences, adapt to changes in user behavior, and enhance the overall personalization and efficiency of the retrieval and recommendation process. Returning to the example of a user walking down the street, looking at an advertisement for at least a threshold length of time, and interaction and attention module 210 automatically generate a copy of the advertisement for future retrieval. In this example, contextualization module 215 may generate context-based tags that might include the time of day, the street the user was walking on, the content of the advertisement, information about how to access the product being advertised, and more.

In accordance with aspects of the present invention, request handling module 220 is configured to receive a natural language request for data associated with the specific item. In embodiments, the natural language request may comprise a request uttered by the user wearing the VR and/or AR device (e.g., user device 240 of FIG. 2) and captured by a microphone on the VR and/or AR device. Request handling module 220 may also be configured to transmit data associated with and/or describing the copy of the specific item in response to the natural language request. For example, the data may be transmitted to the VR and/or AR device to be displayed for the user wearing the VR and/or AR device. In embodiments, request handling module 220 may comprise and/or employ an advance request handling and memory management module that is in communication with personalization data storage and/or a memory management system (i.e., one or more instances of data source 230 of FIG. 2).

In accordance with aspects of the present invention, integration module 225 is configured to establish application program interface (API) integrations. Specifically, integration module 225 may be configured to facilitate the digitization of real-world objects by connecting with external resources, such as online libraries or platforms having digitized contents. For example, when a user views a physical object, such as a book, the system utilizes these API integrations to identify the corresponding digital counterpart and store a reference to the corresponding digital counterpart. This enables seamless linking between the physical and digital realms, allowing for efficient retrieval and interaction with the digital equivalent of the object. In embodiments, the integrations provided by integration module 225 may be used by interaction and attention module 210, contextualization module 215, and request handling module 220 to enhance their respective features.

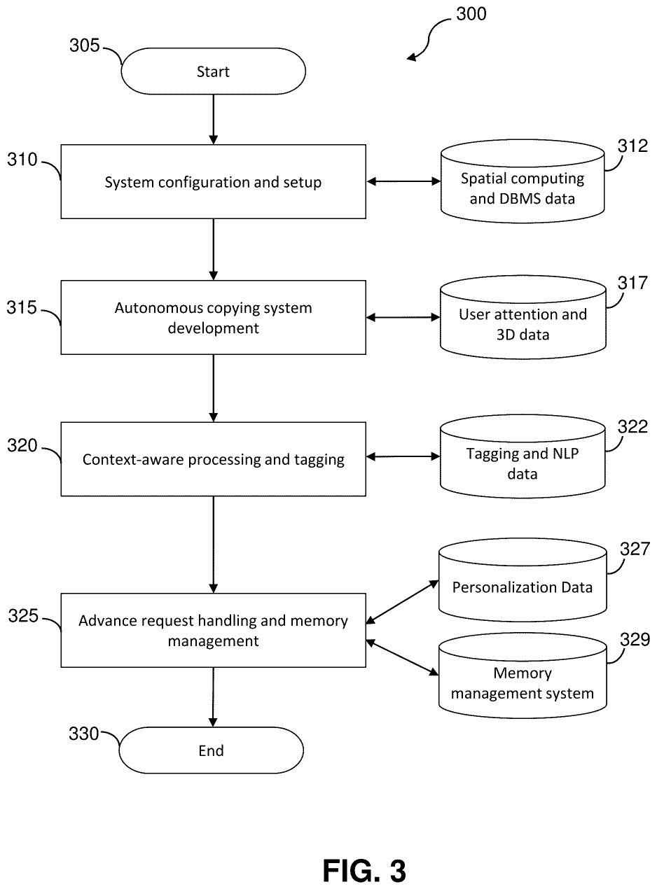

FIG. 3 shows a flowchart of exemplary method 300 in accordance with aspects of the present invention. Steps of the method (also referred to as operations) may be carried out in the environment of FIG. 2 and are described with reference to elements depicted in FIG. 2.

At operation 305 of FIG. 3, spatial computing server 205 of FIG. 2 is configured to initialize method 300. At operation 310, spatial computing server 205 is configured to gather and configure systems and technologies to support the operations of interaction and attention module 210, contextualization module 215, request handling module 220, and integration module 225. In embodiments, spatial computing server 205 establishes a spatial computing and database management system (DBMS) data system 312. As provided above, a DBMS refers to a software system designed to manage, store, and organize data in a structured way. It allows users to create, read, update, and delete data while ensuring data integrity, security, and efficient access. In embodiments, the DBMS 312 serves as a central repository for objects and data that are referenced by users in an application. In embodiments, the DBMS 312 provides essential functionalities such as data storage, query processing, transaction management, and backup recovery, ensuring that data is available, consistent, and accessible. In embodiments, the DBMS 312 may be implemented using cloud-based solutions or any other scalable and reliable managed database services suitable for handling large volumes of data with high availability.

In embodiments, operation 310 may include initializing a virtual reality headset and/or an augmented reality headset and ensure that the headset is equipped with eye-tracking sensors capable of capturing eye-movement and attention data as described with respect to interaction and attention module 210 of FIG. 2. In embodiments, operation 310 may include initializing a database management system (DBMS) system (e.g., one or more instances of DBMS data system 312), to store references to objects identified by the user. In embodiments, the DBMS 312 system may be implemented as a cloud-based solution to ensure scalability and reliability.

In embodiments, operation 310 may include initializing API integrations with external resources such as databases, data libraries, Internet resources, and more. In embodiments, spatial computing server 205 of FIG. 2 and integration module 225 of FIG. 2 work in coordination to establish these API integrations with external resources.

In embodiments, operation 310 may include installing, initializing, and/or configuring software libraries (e.g., one or more instances of data source 230 and/or knowledge base 235 of FIG. 2) based on the machine learning, deep learning, and natural language processing needs of the machine learning models used in the system. For example, as noted above interaction and attention module 210 may employ machine learning models trained to analyze and/or interpret the user eye movements and gaze patterns. As noted above, machine learning models used by the system (e.g., interaction and attention module 210) may include one or more of supervised learning models, unsupervised learning models, deep learning models, and/or any other machine learning model capable of inferring a user intent based on a received user interaction and/or a user eye moment. In such embodiments, the machine learning model(s) may have access to historical and/or real time user attention data and/or historical 3D data and may be trained using the historical and/or real time user attention data and/or historical 3D data.

At operation 315, the system (e.g., interaction and attention module 210 of FIG. 2) is configured to perform autonomous copying system development. In embodiments, interaction and attention module 210 captures and/or receives user attention and 3D data 317 and analyze and/or interpret user eye movements based the user attention and 3D data 317. In embodiments, interaction and attention module 210 generates a copy of the specific item based on user attention and 3D data 317. In other words, interaction and attention module 210 may comprise and/or employ an autonomous copying system that generates a copy of an item that caught the user's attention.

In embodiments, operation 315 includes designing algorithms and training the machine learning models to analyze and/or perceive user interest. The algorithms and machine learning models may be further designed and trained to translate and/or interpret the user interest into meaningful data that may be used in determining whether to copy data based on the user interest. In embodiments, the algorithms may include eye-tracking data processing algorithms that filter the user's attention and/or focus from raw gaze data. In other words, the algorithm may filter out noise while also identifying fixation points and/or recording saccadic movements. During a training process (e.g., a training phase), the user may be prompted to provide feedback to help train the algorithm to filter and decipher the user attention from the raw gaze data. For example, during a training phase, the system (e.g., interaction and attention module 210 of FIG. 2) may identify that a user held a fixation point on an object for a threshold period. In embodiments, the system may prompt the user with a question such as “were you interested in the object?” If the user confirms interest in the object, the threshold period my remain the same. However, if the user denies interest in the object, the threshold period of time and/or the gaze analytics may be adjusted based on the user feedback. In embodiments, the gaze analytics used to determine user attention and/or focus from raw gaze data may include CNNs for pattern recognition, RNNs to capture temporal dynamics in eye movement data, and/or any other machine learning model capable of tracking a user attention and/or focus.

In embodiments, operation 315 includes creating and/or initializing 3D scanning and image recognition systems. In other words, the system (e.g., interaction and attention module 210 of FIG. 2) may be configured to use virtual reality and/or augmented reality technologies to scan a 3D structure of an object. With the scanned 3D structure, the system may find a digital equivalent or digital representation of the scanned object. For example, if a user gazes at a specific car model, the system uses this 3D scanning and image recognition to identify the make and model and find an online 3D model or description of the specific car. In embodiments, the 3D scanning may also be employed in a virtual reality environment. For example, if a user gazes at a specific car model within a virtual reality environment, the system may use the 3D scanning and image recognition to identify the make and model and find a 3D model or description of the specific car outside the virtual reality environment.

In embodiments, operation 315 may further include generating a copy of the specific item based on the determined user interest. In other words, the system (e.g., interaction and attention module 210) may include and/or employ an autonomous copying system that generates a copy of an item and/or object that caught the user's attention. In such embodiments, the copy of the specific item may be stored in memory (e.g., DBMS data system 312).

At operation 320, the system (e.g., contextualization module 215 of FIG. 2) is configured to initiate context-aware processing and tagging. In embodiments, the system generates and stores context-based tags for copied items in tagging and NLP data 322. For example, the system may analyze the item and generate tags that reflect its content, relevance, and/or relationship to the user's current context. This may include tags related to the type of content, location, time of day, and/or the user's previous interactions or preferences. In embodiments, these tags can help organize and categorize the copied items for efficient future retrieval, enabling personalized content recommendations, and/or context-aware search functionalities. Additionally, the system may leverage metadata such as geographic data, social signals, and/or environmental factors to enhance the relevance of the generated tags.

In embodiments, operation 320 may include generating context-based tags for stored items. For example, the system (e.g., contextualization module 215 of FIG. 2) may analyze the item and generate tags that reflect its content, relevance, and/or relationship to the user's current context. This may include tags related to the type of content, location, time of day, and/or the user's previous interactions or preferences. In embodiments, these tags can help organize and categorize the copied items for efficient future retrieval, enabling personalized content recommendations, and/or context-aware search functionalities. Additionally, the system may leverage metadata such as geographic data, social signals, and/or environmental factors to enhance the relevance of the generated tags. For example, if a user gazes at a digital painting in a virtual art gallery for a long time, the system might tag the copied item with “art,” “painting,” and “long interest.” Furthermore, items that are in proximity to other copied items, before and/or after in time, may also be tagged. In embodiments, the system may also apply temporal tags that allow objects to be temporally related to other objects. This functionality allows for interactions like the following voice command: “Copy the picture of the sports car I was browsing online before I went to dinner with my friend Jeremy yesterday.”

In embodiments, operation 320 may use a machine learning model to generate context-based tags for the copied items. For example, the system (e.g., contextualization module 215) may use machine learning models such as NLP models, CNNs, and/or RNNs to analyze the content of the item and/or generate relevant tags. In embodiments, NLP models may be used to process textual content to extract key terms, sentiments, and entities. In embodiments, CNNs may be used to analyze visual content (e.g., images or videos) for identifying patterns or objects. In yet additional embodiments, RNNs, may be used to capture sequential data such as interactions over time, allowing the system to better understand the context and the user's evolving preferences. These machine learning models, trained on large datasets, can help contextualization module 215 adapt and improve the tagging process over time, creating more accurate and personalized context-based tags. In embodiments the training data (e.g., historical tagging and machine learning data) may be stored in a database (i.e., one or more instances of knowledge base 235 of FIG. 2).

In embodiments, operation 320 may include resizing a copied item and/or the copied item's contents. In other words, the system may adjust the dimensions and/or resolution of the copied item to optimize its storage requirements, fit it into a specific layout, or enhance its visual quality for a particular context and/or user preference. In embodiments, operation 320 may also modify the copied item based on a user preference. For example, in embodiments, a user may indicate that copied items be stored using a minimal resolution to preserve memory. In other embodiments, a user may indicate that copied items should be retained for specific periods of time, including based on the user's detected interest. Furthermore, some copied items may be stored at a minimal resolution while others are stored in an original format based on the user's indicated interest in a particular topic. For example, if the user has indicated an interest in cars, the system will not reduce the size of the copied items having contextual tags that indicate car-related items. In such embodiments, the user's interest may be determined based on a detected interest (in accordance with operation 315), based on a user's information requests, and/or based on an express indication via user input.

In embodiments, operation 320 may include generating a natural language context description of stored items. In embodiments, the natural language context is based on the tags assigned to an item and/or series of related items. For example, a copied item from a virtual museum tour might include a description such as “This is the Van Gogh painting you admired during the museum tour on June 12th.”

At operation 325, the system (e.g., request handling module 220 of FIG. 2) is configured to initialize advance request handling and memory management practices based on personalized data 327 and memory management system 329. In embodiments, the system (e.g., request handling module 220 of FIG. 2) may receive a natural language request for data associated with the specific item. The system may also be configured to transmit data associated with and/or describing the copy of the specific item in response to the natural language request. For example, in embodiments, the system may comprise and/or employ an advance request handling and memory management module that is in communication with personalization data storage and/or a memory management system (i.e., one or more instances of data source 230 of FIG. 2). In other words, if a user requests, “Share the books I copied yesterday with John in the order I looked at them,” the system will understand and carry out this task by presenting the books the user copied in the order that the user looked at the books.

In embodiments, operation 325 may include traceability features. As used herein, traceability refers to the ability to track, verify, and/or provide the origin and history of an item or its components. Therefore, traceability promotes transparency and gives users an ability to further explore object sources. For instance, a copied artifact from a virtual museum could carry a link to the museum's online catalog and/or a link to other source documents related to the object.

At operation 330, method 300 ends. In embodiments, before method 300 ends, the system (e.g., spatial computing server 205 or modules of spatial computing server 205) may be configured to output, transmit, and/or display copied item references (i.e., pointers or links to the original items that the user interacted with); contextual tags (i.e., tags assigned to copied items based on the user's interaction and interest levels; natural language descriptions (i.e., descriptions generated for each copied item based on context and interaction); advanced request outputs (i.e., results from complex tasks requested by the user, such as a sequence of copied books or anonymized information); copied item source links (i.e., links to the original source of the copied items for further exploration; memory management updates (i.e., updates on memory usage, storage efficiency, status of copied items, and whether the original item is saved or deleted); user interaction and request logs (i.e., logs of the user's interactions, commands, and requests); and more. In embodiments, the data output, transmitted, and/or displayed is determined based on the context-based tags for the specific item. In other words, the closer the tags are a user's natural language request, the more accurately the system can provide the output to reflect the user's request.

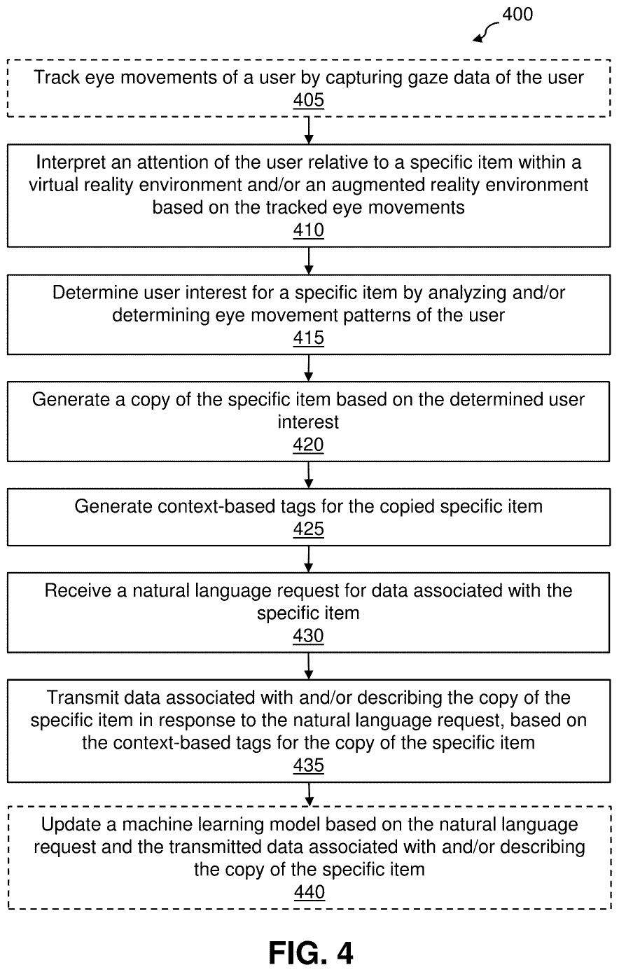

FIG. 4 shows a flow diagram of an exemplary method 400 in accordance with aspects of the present invention. Operations of the method 400 are described with reference to elements and actions depicted in and described with reference to FIGS. 2 and 3.

At operation 405, the system (e.g., one or more instances of interaction and attention module 210 of FIG. 2) may be optionally configured (as indicated by the dotted lines) to track eye movements of a user by capturing gaze data of the user. In embodiments, operation 405 may be performed in accordance with operations 310 and 315 of FIG. 3 and/or in accordance with the description of interaction and attention module 210 of FIG. 2. For example, interaction and attention module 210 may track eye movements by capturing gaze data of the user.

At operation 410, the system (e.g., one or more instances of interaction and attention module 210) is configured to interpret an attention of the user relative to a specific item within a virtual reality environment and/or an augmented reality environment based on the tracked eye movements. In embodiments, operation 410 may be performed in accordance with operations 310 and 315 of FIG. 3 and/or in accordance with the description of interaction and attention module 210 of FIG. 2. For example, interaction and attention module 210 may interpret an attention or interaction of a user based on the obtain eye-tracking data and/or other user-interaction data. For example, in embodiments, the attention of the user relative to a specific item within a virtual reality environment and/or an augmented reality environment may be determined, analyzed, and/or interpreted based on the tracked eye movements.

At operation 415, the system (e.g., one or more instances of interaction and attention module 210) is configured to determine user interest for a specific item by analyzing and/or determining eye movement patterns of the user. In embodiments, operation 415 may be performed in accordance with operations 310 and 315 of FIG. 3 and/or in accordance with the description of interaction and attention module 210 of FIG. 2. For example, interaction and attention module 210 may track eye movements such as fixation points (where the eyes are focused), saccades (quick eye movements between fixations), and blink rates, the model can infer a user level of engagement, identify areas of interest, and/or predict user intent. In embodiments, module 210 analyzes and/or interprets user eye movements relative to specific items. For example, if a user is walking down the street and looks at an advertisement for at least a threshold length of time, interaction and attention module 210 may determine that the user is interested in the contents of the advertisement.

At operation 420, the system (e.g., one or more instances of interaction and attention module 210) is configured to generate a copy of the specific item based on the determined user interest. In embodiments, operation 420 may be performed in accordance with operations 310 and 315 of FIG. 3 and/or in accordance with the description of interaction and attention module 210 of FIG. 2. For example, interaction and attention module 210 may comprise and/or employ an autonomous copying system that generates a copy of an item that caught the user's attention. For example, upon determining that a user is interested in the contents of the advertisement, interaction and attention module 210 may automatically generate a copy of the advertisement for future retrieval.

At operation 425, the system (e.g., one or more instances of contextualization module 215) is configured to generate context-based tags for the copied specific item. In embodiments, operation 430 may be performed in accordance with operation 320 of FIG. 3 and/or in accordance with the description of contextualization module 215 of FIG. 2, above. For example, contextualization module 215 may analyze the item and generate tags that reflect its content, relevance, and/or relationship to the user's current context. This may include tags related to the type of content, location, time of day, and/or the user's previous interactions or preferences. In embodiments, these tags can help organize and categorize the copied items for efficient future retrieval, enabling personalized content recommendations, and/or context-aware search functionalities. Additionally, contextualization module 215 may leverage metadata such as geographic data, social signals, and/or environmental factors to enhance the relevance of the generated tags.

At operation 430, the system (e.g., one or more instances of request handling module 220 of FIG. 2) is configured to receive a natural language request for data associated with the specific item. In embodiments, operation 430 may be performed in accordance with operation 325 of FIG. 3 and/or in accordance with the description of request handling module 220 of FIG. 2, above. For example, contextualization module 215 may receive a natural language request for data associated with the specific item. In embodiments, the natural language search may reference past events, including past dates and times. For example, a user wearing the VR and/or AR device may utter “please show me the yellow car that I saw on January 16 at around noon while I was walking to lunch.” In such embodiments, the system could determine and access contextual tags that referenced a car, yellow, January 16, noon, walking, lunch, and/or any other tag that may be applicable to a yellow car that caught the user's interest and attention while walking to lunch on January 16. In this manner, the system may search for past events based referenced events, dates, and times.

In embodiments the natural language request is received from a program-specific search tool related to the spatial computing and DBMS data 312, user attention and 3D data 317, tagging and NLP data 322, and/or personalization data 327. In other words, in embodiments, a user may only perform a natural language search using a search engine that is part of and/or related to the data and program managed and/or accessed by spatial computing server 205. For example, a program-specific search tool may be available to a user while the user is wearing the VR and/or AR device. In such embodiments, the program-specific search tool has access to historical contextual tags. Accordingly, the user may utter a natural language search request and/or the user may manually enter (e.g., type and/or write) a natural language search request using an interface related to the program-specific search tool provided at the VR and/or AR device. In embodiments, the program-specific search tool is included in the improved spatial computing and context-aware resource sharing code 200 of FIG. 1.

At operation 435, the system (e.g., one or more instances of request handling module 220 of FIG. 2) is configured to transmit data associated with and/or describing the copy of the specific item to a user device (e.g., VR and/or AR device) to be displayed at the user device in response to the natural language request. In embodiments, operation 435 may be performed in accordance with operation 325 of FIG. 3 and/or in accordance with the description of request handling module 220 of FIG. 2, above.

At operation 440, the system (e.g., one or more instances of interaction and attention module 210 and/or contextualization module 215) may optionally be configured to update, train, and/or retrain a machine learning model based on the received natural language request and the transmitted data associated with and/or describing the copy of the specific item retrieved in response to the natural language request. In embodiments, operation 440 may be performed in accordance with the descriptions of interaction and attention module 210 and/or contextualization module 215 of FIG. 2, above. For example, contextualization module 215 may include a feedback loop to retrain the machine learning models. In other words, contextualization module 215 may be configured to update its machine learning model(s) based on a user's natural language requests. For example, the system may learn and adapt to a user's language and preferences through the user's natural language requests. This information can help refine the context-based tags, improve the relevance of content suggestions, and enable the system to more accurately predict the user needs and interests. By continuously incorporating user feedback, the system can better understand nuanced preferences, adapt to changes in user behavior, and enhance the overall personalization and efficiency of the retrieval and recommendation process.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
interpreting an attention of a user relative to a specific item within a virtual environment;
determine user interest for the specific item by analyzing eye movement patterns of the user;
generating a copy of the specific item based on the determined user interest;
generating context-based tags for the copy of the specific item;
receiving a natural language request for data associated with the specific item, wherein the data associated with the specific item is determined based on the context-based tags for the copy of the specific item; and
transmitting the copy of the specific item to a user device to be displayed at the user device in response to the natural language request.

2. The method of claim 1, wherein the virtual environment is a virtual reality environment or an augmented reality environment.

3. The method of claim 1, further comprising tracking eye movements of the user by capturing gaze data of the user.

4. The method of claim 3, wherein the interpreting the attention of the user relative to the specific item comprises interpreting the gaze data of the user in real time and determining that the user looked at the specific item for more than a threshold length of time.

5. The method of claim 1, wherein the copy of the specific item comprises a reference of the specific item, and wherein the transmitting the copy of the specific item in response to the natural language request comprises transmitting the reference of the specific item.

6. The method of claim 1, wherein the context-based tags are generated using at least one machine learning model configured to identify items within an image.

7. The method of claim 1, wherein receiving the natural language request comprises receiving a natural language user input through a program-specific search tool.

8. The method of claim 7, wherein the natural language user input comprises a past date and a past time.

9. The method of claim 7, wherein the natural language user input comprises a reference to a past event that the user experienced.

10. The method of claim 1, further comprising modifying the copy of the specific item based on a user preference.

11. A computer program product comprising:
one or more computer-readable storage media; and
program instructions stored on the one or more computer-readable storage media to perform operations comprising:
interpreting an attention of a user relative to a specific item within a virtual environment;
determine user interest for the specific item by analyzing eye movement patterns of the user;
generating a copy of the specific item based on the determined user interest;
generating context-based tags for the copy of the specific item;
receiving a natural language request for data associated with the specific item, wherein the data associated with the specific item is determined based on the context-based tags for the copy of the specific item; and
transmitting the copy of the specific item to a user device to be displayed at the user device in response to the natural language request.

12. The computer program product of claim 11, wherein the operations further comprise tracking eye movements of the user by capturing gaze data of the user, wherein the interpreting the attention of the user relative to the specific item comprises interpreting the gaze data of the user in real time and determining that the user looked at the specific item for more than a threshold length of time.

13. The computer program product of claim 11, wherein the copy of the specific item comprises a reference of the specific item, and wherein the transmitting the copy of the specific item in response to the natural language request comprises transmitting the reference of the specific item.

14. The computer program product of claim 11, wherein the context-based tags are generated using at least one machine learning model configured to identify items within an image.

15. The computer program product of claim 11, wherein receiving the natural language request comprises receiving a natural language user input through a program-specific search tool, and wherein the natural language user input comprises a past date and a past time.

16. A computer system comprising:
a processor set;
one or more computer-readable storage media; and
program instructions stored on the one or more computer-readable storage media to cause the processor set to perform operations comprising:
interpreting an attention of a user relative to a specific item within a virtual environment;
determine user interest for the specific item by analyzing eye movement patterns of the user;
generating a copy of the specific item based on the determined user interest;
generating context-based tags for the copy of the specific item;
receiving a natural language request for data associated with the specific item, wherein the data associated with the specific item is determined based on the context-based tags for the copy of the specific item; and
transmitting the copy of the specific item to a user device to be displayed at the user device in response to the natural language request.

17. The computer system of claim 16, wherein the operations further comprise tracking eye movements of the user by capturing gaze data of the user, wherein the interpreting the attention of the user relative to the specific item comprises interpreting the gaze data of the user in real time and determining that the user looked at the specific item for more than a threshold length of time.

18. The computer system of claim 16, wherein the copy of the specific item comprises a reference of the specific item, and wherein the transmitting the copy of the specific item in response to the natural language request comprises transmitting the reference of the specific item.

19. The computer system of claim 16, wherein the context-based tags are generated using at least one machine learning model configured to identify items within an image.

20. The computer system of claim 16, wherein receiving the natural language request comprises receiving a natural language user input through a program-specific search tool, and wherein the natural language user input comprises a reference to a past event that the user experienced.
